(19) United States
(12) Patent Application Publication
(10) Pub. No.: US 2007/0248783 A1
(43) Pub. Date: Oct. 25, 2007

(54) OPTICAL INFORMATION RECORDING MEDIA

(75) Inventors: Hironori KAKIUCHI, Kobe-shi (JP); Hideo Fujii, Kobe-shi (JP); Yuki Tauchi, Kobe-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd), Kobe-shi (JP)

(21) Appl. No.: 11/695,278

(22) Filed: Apr. 2, 2007

(30) Foreign Application Priority Data
Apr. 24, 2006 (JP) 2006-119429

(51) Int. Cl. B32B 3/02

(52) U.S. Cl. 428/64.4

(57) ABSTRACT

An optical information recording medium includes a substrate and a recording layer arranged on or above the substrate, configured to bear recording marks upon irradiation of energy beams, and containing a tin-based alloy. The optical information recording medium further includes at least one dielectric layer adjacent to the recording layer, and the at least one dielectric layer mainly includes at least one oxide of an element selected from silicon, magnesium, tantalum, zirconium, manganese, and indium.

### BACKGROUND OF THE INVENTION

1. Field of the Invention

The present invention relates to recording media for the recording of optical information. Optical information recording media according to embodiments of the present invention are usable as current optical information recording media such as CDs (compact discs) and DVDs (digital versatile discs), and next-generation optical information recording media such as HDDVDs and Blu-ray discs. They can be particularly advantageously used as write-once high-density optical information recording media configured to be applied with blue-violet laser beams.

2. Description of the Related Art

Optical information recording media (optical discs) are categorized by the writing/reading system into three main types, i.e., read-only, write-once, and rewritable optical discs.

Of these optical discs, write-once optical discs are so configured that energy beams, such as laser beams, are applied to a recording layer (hereinafter also referred to as “optical recording layer”) to thereby change properties of a material constituting the layer, and data are stored in the media using these changes. Write-once optical discs are configured to record information but not configured to erase and rewrite the recorded data. Write-once optical discs are therefore widely used to prevent tampering of data such as text files and image files using these properties and include, for example, CD-R, DVD-R, and DVD+R discs.

Materials for recording layers in write-once optical discs include organic dye materials such as cyanine dyes, phthalocyanine dyes, and azo dyes. When a laser beam is applied to an organic dye material, the dye absorbs heat, and the dye and a substrate decompose, melt, and/or evaporate to thereby create a recording mark. However, an organic dye material, if used, is dissolved in an organic solvent before being applied to a substrate, which results in a reduction in productivity. Such organic dye materials are also insufficient in storage stability of recorded signals.

As a possible solution to improve disadvantages of organic dye materials, there have been proposed a technique of carrying out information recording by locally forming recording marks (hereinafter also referred to as “system of locally forming recording marks”). In this system, information recording is conducted by applying laser beams to a thin film of an inorganic material as a recording layer and thereby locally forming recording marks such as holes or pits (Appl. Phys. Lett., 34 (1979), 835; Japanese Unexamined Patent Application Publication (JP-A) No. 2004-5922, JP-A No. 2004-234717, JP-A No. 2002-172861, JP-A No. 2002-144730, JP-A No. Hei O₂-117887, JP-A No. 2001-180114, and JP-A No. 2002-225433). As another possible solution than the system of locally forming recording marks, there have been proposed techniques of recording by the action of phase change or alloying of a thin film of an inorganic material. In these techniques, however, a multilayer thin film of inorganic material including three or more layers is deposited and stacked typically by sputtering. They therefore use special production lines and are disadvantageous in production cost. In contrast, the system of locally forming recording marks uses one or two thin film layers of inorganic material to constitute a recording layer, and is advantageous in productivity and production cost.

The system of locally forming recording marks, however, shows a recording sensitivity lower than that of the technique of recording by the action of phase change or alloying of an inorganic material thin film. According to the system of locally forming recording marks, an inorganic material thin film as a recording layer is melted by the action of laser beams to form recording marks such as holes or pits. The laser beams are applied in order to elevate the temperature of the thin film to a temperature equal to or higher than the melting point of the inorganic material thin film and thereby require a high laser power.

When laser beams with a high laser power are applied to melt an inorganic material thin film and to form recording marks such as holes or pits, the melted film may often remain as droplets in the pots around the holes or pits. Such residual droplets derived from a melted film suppress a change in reflective index in the recording marks so as to fail to provide a sufficient degree of signal modulation.

To solve these disadvantages in the system of locally forming recording marks, there have been proposed various procedures. For example, in the technique disclosed in Appl. Phys. Lett., 34 (1979), 835, holes are created in a tellurium (Te) thin film by applying laser beams with a low laser power, which tellurium thin film has a low melting point and a low thermal conductivity.

JP-A No. 2004-5922 and JP-A No. 2004-234717 disclose a multilayer recording layer including a reactive layer formed of a copper-based (Cu-based) alloy containing aluminum (Al), and another reactive layer containing, for example, silicon (Si). By applying a laser beam, atoms contained in the respective reactive layers are mixed partially in a region on a substrate, and the region shows a significantly changed reflectivity. On the basis of the change in reflectivity, information can be recorded with a high sensitivity even if a laser beam having a short wavelength, such as blue laser, is applied.

JP-A No. 2002-172861, JP-A No. 2002-144730, and JP-A No. 2002-225433 disclose optical recording media which are configured to prevent decrease in carrier-to-noise ratio (C/N ratio) in output and to have a high C/N ratio and a high reflectivity. The recording layers in these media use a copper-based alloy containing indium (In) (JP-A No. 2002-172861), a silver-based (Ag-based) alloy typically containing bismuth (Bi) (JP-A No. 2002-144730), and a tin-based (Sn-based) alloy typically containing bismuth (JP-A No. 2002-225433).

JP-A No. Hei 02-117887 and JP-A No. 2001-180114 relate to optical information recording media using tin-based alloys. JP-A No. Hei 02-117887 relates to optical recording media containing two or more different atoms that can aggregate at least partially upon heat treatment in a metal alloy layer. Specifically, there is disclosed an optical information recording medium including a tin-copper-based alloy layer having a thickness of 1 to 8 nm and containing Bi and In, and there is mentioned that this recording medium has a high melting point and a high thermal conductivity.

JP-A No. 2001-180114 discloses an optical information recording layer. This recording layer mainly contains a silicon-bismuth (Si—Bi) alloy having excellent recording properties and further contains a material more susceptible to oxidation than tin (Sn) and bismuth (Bi). The document mentions that the resulting optical recording medium shows increased durability even under high temperature and high humidity conditions

### SUMMARY OF THE INVENTION

As the demand for high-density information recording grows more and more, there has been developed a technique of carrying out recording and reading of information using a short-wavelength laser beam such as blue-violet laser beam. Recording layers for use in this technique should have various properties such as (1) high-quality writing and reading of signals, (2) a high recording sensitivity, (3) a high reflectivity of the recording layers, and (4) high corrosion resistance. More specifically, (1) signals should be written in and read from the recording layers with high quality. Specifically, the recording layers should have a high C/N ratio, namely, signals are intensive (strong) and background noise is small upon reading. They should also have a low jitter, namely, there is a small variation in signal position. In addition,

(2) they should have a high recording sensitivity, namely, writing can be carried out with laser beams at a low power.

However, the metal recording layers according to the technique of forming recording marks in related art do not satisfy all these requirements or do not sufficiently satisfy all these requirements. Accordingly, they are insufficient in practical use.

Above-mentioned JP-A No. Hei 2-117887 discloses an optical recording layer having a thickness of 2 to 4 nm and including a 55 mass % In-40 mass % Sn-5 mass % Cu alloy. This alloy contains, in terms of atomic percent, 53.5 atomic percent of In, 37.7 atomic percent of Sn and 8.8 atomic percent of Cu. It is difficult, however, to yield a practically sufficient C/N ratio using this optical recording layer. The alloy layer disclosed in this document has a thickness of 2 to 4 nm. This thickness, however, is too small for the alloy composition to yield a practically sufficient reflectivity.

JP-A No. 2001-180114 discloses a recording layer containing a Si—Bi alloy having excellent recording properties in combination with a material more susceptible to oxidation than Sn and Bi. This alloy, however, fails to provide a C/N ratio and a recording sensitivity higher than those in a tin-based alloy recording layer according to an embodiment of the present invention.

JP-A No. 2002-225433 discloses an optical recording layer containing a tin-based alloy. This tin-based alloy contains 84 atomic percent of tin (Sn), 10 atomic percent of zinc (Zn) and 6 atomic percent of antimony (Sb). Even this tin-based alloy, however, fails to provide a C/N ratio, a recording sensitivity, and a reflectivity higher than those in a tin-based alloy recording layer according to an embodiment of the present invention.

Metallic recording layers, however, are still significantly advantageous in that their materials are further more stable than those in organic recording layers. It is therefore desirable to develop a practical recording layer satisfying the above-mentioned requirements using a metal material. This will provide BD-R and HDDVD-R discs as highly reliable optical information recording media.

The present inventors, therefore, proposed optical information recording layers containing tin-based alloys, which recording layers satisfy the requirements (1) to (4), have a high reliability in recording accuracy, and are available at low cost in Japanese Patent Applications No. 2005-376059 and No. 2006-4099. The proposed tin-based alloys contain 1 to 50 atomic percent of at least one of nickel (Ni) and cobalt (Co), 1 to 15 atomic percent of at least one rare-earth element, and 30% or less (excluding 0%) of at least one selected from the group consisting of indium (In), bismuth (Bi), and zinc (Zn), relative to tin (Sn).

The resulting optical information recording layers containing the proposed tin-based alloys, however, are still susceptible to improvements in degree of signal modulation, although they satisfy the requirements (1) to (4).

Under these circumstances, it is desirable to provide an optical information recording medium having a recording layer containing a tin-based alloy, which recording medium has a high degree of signal modulation as well as superior basic properties as an optical disc.

According to an embodiment of the present invention, there is provided an optical information recording medium which includes a substrate, and a recording layer arranged on or above the substrate and configured to bear recording marks upon irradiation of energy beams. In the medium, the recording layer includes a tin-based alloy, the optical information recording medium further includes at least one dielectric layer adjacent to the recording layer, and the at least one dielectric layer mainly includes at least one oxide of an element selected from silicon (Si), magnesium (Mg), tantalum (Ta), zirconium (Zr), manganese (Mn), and indium (In).

The dielectric layer is preferably arranged between the substrate and the recording layer including the tin-based alloy. The tin-based alloy preferably contains 1 to 50 atomic percent of at least one of nickel (Ni) and cobalt (Co) and 0.5 to 10 atomic percent of at least one rare-earth element, with the remainder being tin (Sn) and inevitable impurities.

If an optical information recording medium simply contains a recording layer including a tin-based alloy, recording marks such as holes or pits can be locally formed in the recording layer, and the recording medium shows a good recording sensitivity, because tin (Sn) constituting a parent phase has a low melting point and can be melted even at a low laser power.

The low melting point of tin in the recording layer, however, causes a specific problem. Namely, the shapes of local recording marks such as holes or pits, if formed at a low laser power, significantly vary depending on the wettability of tin. This problem leads to a variation in degree of signal modulation. The recording layer is therefore still susceptible to improvements in frequently decreased degree of signal modulation.

More specifically, if tin has excessively high wettability, melted tin does not spread over grooves having a constant track pitch (guide grooves or pits) but often locally remains as droplets in pots where holes or pits are formed by melting tin. The droplets derived from melted tin may possibly inhibit the change in reflectivity in the recording marks and may suppress the degree of signal modulation. Conversely, if tin has poor wettability, melted tin may be unevenly distributed typically on vertical walls around the grooves and be solidified therein. This may also possibly inhibit the change in reflectivity in the recording marks and may suppress the degree of signal modulation from increasing.

In contrast, according to an embodiment of the present invention, the wettability of tin is controlled during the formation of local recording marks by the action of laser power. The control is carried out by arranging at least one specific dielectric layer adjacent to the tin-based alloy recording layer. The dielectric layer mainly includes at least one oxide of an element selected from the group consisting of silicon (Si), magnesium (Mg), tantalum (Ta), zirconium (Zr), manganese (Mn), and indium (In). This prevents the uneven distribution of tin in the form typically of residual droplets derived from melted tin and unevenly distributed solidified tin and thereby enables satisfactory formation of local recording marks by the action of laser power. Thus, decrease in degree of signal modulation can be prevented.

Consequently, there can be provided an optical information recording medium which has a recording layer containing a tin-based alloy, has a high degree of signal modulation and superior basic properties as an optical disc, according to an embodiment of the present invention.

### BRIEF DESCRIPTION OF THE DRAWINGS

FIGS. 1A and 1B are schematic cross sectional views of optical information recording media according to an embodiment of the present invention;

FIGS. 2A and 2B are schematic cross sectional views of optical information recording media according to another embodiment of the present invention;

FIGS. 3A and 3B are schematic cross sectional views of optical information recording media according to yet another embodiment of the present invention; and

FIGS. 4A, 4B, 4C, and 4D are schematic cross sectional views of optical information recording media according to a further embodiment of the present invention.

### DESCRIPTION OF THE PREFERRED EMBODIMENTS

General Configuration of Optical Information Recording Media

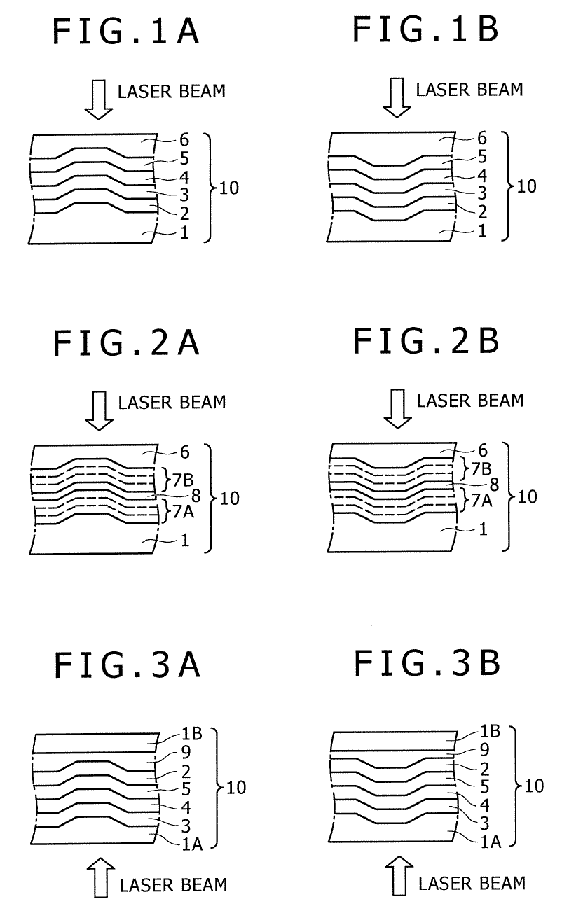

General and basic configurations of optical information recording media (optical discs) according to embodiments of the present invention will be illustrated below with reference to the attached drawings. FIGS. 1A, 1B, 2A, 2B, 3A, 3B, 4A, 4B, 4C, and 4D are schematic cross sectional views showing write-once optical information recording media according to embodiments of the present invention by way of example. These recording media are configured to write and read data by applying a laser beam with a wavelength of about 350 to 700 nm to a recording layer. The recording media shown in FIGS. 1A, 2A, 3A, 4A, and 4C each have a convex recording site, and those shown in FIGS. 1B, 2B, 3B, 4B, and 4D each have a convex grooved recording site.

Each of optical discs 10 shown in FIGS. 1A and 1B includes a supporting substrate 1, an optical control layer 2, dielectric layers 3 and 5, a recording layer 4, and a light transmission layer 6. The recording layer 4 is arranged between the dielectric layers 3 and 5.

Each of optical discs 10 shown in FIGS. 2A and 2B includes a supporting substrate 1, a zeroth recording layer group (a group of layers including an optical control layer, a dielectric layer, and a recording layer) 7A, an intermediate layer 8, a first recording layer group (a group of layers including an optical control layer, a dielectric layer, and a recording layer) 7B, and a light transmission layer 6.

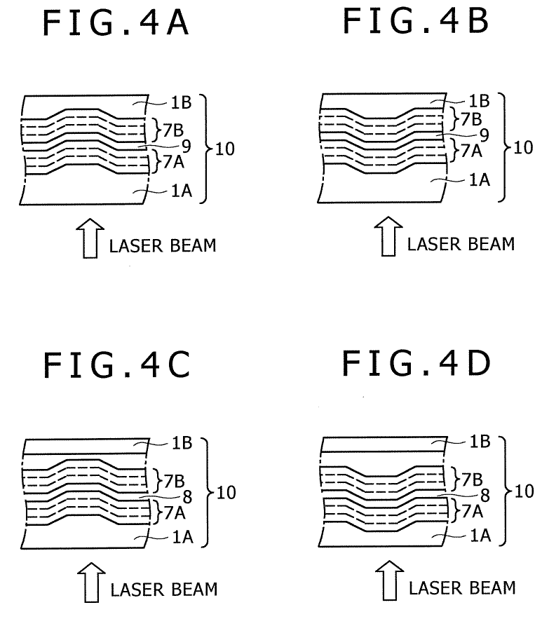

FIGS. 3A and 3B illustrate optical discs of a single-layer DVD-R, a single-layer DVD+R, or a single-layer HDDVD-R type. FIGS. 4A, 4B, 4C, and 4D illustrate optical discs of a double-layer DVD-R, a double-layer DVD+R, or a double-layer HDDVD-R type. These figures also show an intermediate layer 8 and an adhesive layer 9.

A group of layers constituting the zeroth and first recording layer groups 7A and 7B in FIGS. 2A, 2B, 4A, 4B, 4C, and 4D may have a three-layer structure, a two-layer structure, or a single-layer structure containing a recording layer alone. The three-layer structure may be a structure of, for example, (dielectric layer)/(recording layer)/(dielectric layer), (dielectric layer)/(recording layer)/(optical control layer), or (recording layer)/(dielectric layer)/(optical control layer) arranged in this order from above in the figures. The two-layer structure may be a structure of, for example, (recording layer)/(dielectric layer), (dielectric layer)/(recording layer), (recording layer)/(optical control layer), or (optical control layer)/(recording layer) arranged in this order from above in the figures.

An optical information recording medium according to an embodiment of the present invention has the above-mentioned configuration as a basic configuration, in which the recording layer 4 includes a tin-based alloy. The resulting recording medium has a high information-packing density, as mentioned below.

The optical information recording medium according to an embodiment of the present invention further includes dielectric layers 3 and 5 adjacent to the recording layer 4 including a tin-based alloy. The dielectric layers 3 and 5 each mainly include at least one oxide of an element selected from the group consisting of silicon (Si), magnesium (Mg), tantalum (Ta), zirconium (Zr), manganese (Mn), and indium (In).

The dielectric layers 3 and 5 mainly including these oxides function as a dielectric and, in addition, act to control the wettability of the tin-based alloy recording layer 4 during formation of local recording marks by the action of laser power. The control action reduces or avoids the problem specific to a tin-based alloy recording layer. Namely, the action suppresses the uneven distribution of tin as droplets derived from melted tin or as residual solidified lamps of tin during formation of local recording marks by the action of laser power. Thus, local recording marks can be formed satisfactorily. This prevents decrease in degree of signal modulation. These dielectric layers mainly including the oxides also act as a dielectric layer to protect the recording layer 4 and to increase the reflectivity and the C/N ratio.

The dielectric layers 3 and 5 are preferably arranged adjacent to the recording layer 4 including a tin-based alloy, and one of the dielectric layers 3 and 5 is preferably arranged between the recording layer 4 and the substrate 1 so as to control the wettability of the recording layer 4 and to exhibit a dielectric function, as described above.

Tin-Based Alloy Recording Layer

An optical information recording medium according to an embodiment of the present invention basically has a recording layer including a tin-based alloy. The tin-based alloy may be preferably one selected from those proposed in Japanese Patent Applications No. 2005-376059 and No. 2006-4099. Specifically, the tin-based alloy is preferably one selectively containing, relative to tin, 1 to 50 atomic percent of at least one of nickel (Ni) and cobalt (Co), 1 to 15 atomic percent of at least one rare-earth element, and 30% or less (excluding 0%) of at least one selected from indium (In), bismuth (Bi), and zinc (Zn). The remainder other than the alloy elements in the compositions of tin-based alloys such as the after-mentioned tin-based alloys is tin and inevitable impurities.

By constituting a recording layer from these tin-based alloys, the resulting recording medium can be applied to the technique of recording and reproducing data using a laser having a short wavelength, such as blue-violet laser. It enables and ensures a high information packing density. More specifically, the recording layer may satisfy the above-mentioned properties such as (1) high-quality writing/reading of signals typically with a high C/N ratio and a low jitter; (2) a high recording sensitivity; (3) a high reflectivity of the recording layer; and (4) a high corrosion resistance. In addition, the recording layer may exhibit a high reliability in recording accuracy, be available at low cost, and be practical.

Of the above-mentioned tin-based alloys, preferred are tin-based alloys each containing 1 to 50 atomic percent of at least one of nickel (Ni) and cobalt (Co) and 0.5 to 10 atomic percent of at least one rare-earth element, for constituting a recording layer satisfying these properties. Of tin-based alloys of this type, more preferred are Sn—(Ni and/or Co)—Y alloys.

Other preferred combination of elements in tin-based alloys are Sn—(Ni and/or Co), Sn—(Ni and/or Co)—(In, Bi, and/or Zn), and Sn—(Ni and/or Co)-(rare-earth element)-(In, Bi, and/or Zn).

Actions of Tin

When used in an optical recording layer, tin as a base metal (remainder composition) is inferior in reflectivity to aluminum (Al), silver (Ag), and copper (Cu). Tin, however, further more satisfactorily contributes to the formation of recording marks by the action of laser beams than these metals. This is because the melting point of tin is about 232° C. and is significantly lower than those of aluminum (about 660° C.), silver (about 962° C.), and copper (about 1085° C.). Thus, a tin-based alloy thin film is easily melted or deformed upon irradiation with laser beams even at relatively low temperatures, recording marks can be satisfactorily formed thereon even at a low laser power, and the thin film as a recording layer can carry out satisfactory recording.

Accordingly, such tin-based alloy recording layers are advantageously usable in next-generation optical discs configured to be irradiated with blue-violet laser with a relatively low laser power. In contrast, it may be difficult to form recording marks in recording layers in related art containing aluminum, silver, or copper, when the recording layers are used in such next-generation optical discs configured to be irradiated with blue-violet laser with a relatively low laser power.

Alloy Element: Nickel (Ni) and Cobalt (Co)

A tin-based alloy preferably selectively contains 1 to 50 atomic percent of at least one of nickel (Ni) and cobalt (Co) as an alloy element. Nickel and cobalt are elements exhibiting equivalent effects and act to increase the reflectivity and the corrosion resistance and to reduce the jitter. In addition, they act to reduce the surface roughness of the optical recording layer and to thereby optimize shapes of formed recording marks.

If the content of at least one of nickel (Ni) and cobalt (Co) is excessively small, these actions may not be effectively exhibited. The tin-based alloy therefore preferably includes at least one of nickel (Ni) and cobalt (Co) in a total content of 1 atomic percent or more to exhibit these actions effectively. In contrast, if the content of at least one of nickel (Ni) and cobalt (Co) is excessively large, the content of tin is relatively small and the inherent actions of tin may not be effectively exhibited. The total content of at least one of nickel (Ni) and cobalt (Co) in terms of upper limit is preferably 50 atomic percent or less. The total content of at least one of nickel (Ni) and cobalt (Co) is more preferably about 5 to about 35 atomic percent and further preferably about 15 to about 25 atomic percent.

Alloy Element: Rare-Earth Elements

Rare-earth elements as another alloy element are capable of increasing the corrosion resistance and the surface smoothness of a recording layer and are capable of reducing the jitter. A tin-based alloy therefore preferably selectively contains about 0.5 to about 10 atomic percent of at least one rare-earth element. To exhibit these actions effectively, the tin-based alloy may contain at least one rare-earth element in a total content of preferably about 0.5 atomic percent or more and more preferably about 1.0 atomic percent or more. If the total content of rare-earth elements is excessively large, the optical recording layer may have an excessively high melting point, and it may be difficult to form satisfactory recording marks by the action of laser beams. Accordingly, the total content is preferably about 10 atomic percent or less and more preferably about 8 atomic percent or less. Each of rare-earth elements can be used alone or in any combination.

Of rare-earth elements, preferred are yttrium (Y), neodymium (Nd), lanthanum (La), gadolinium (Gd), and dysprosium (Dy). Among them, yttrium (Y) is more preferred when used in combination with the at least one of nickel (Ni) and cobalt (Co) so as to exhibit actions more satisfactorily.

Alloy Elements: Indium (In), Bismuth (Bi), and Zinc (Zn)

A tin-based alloy may further contain, as an alloy element, 30 atomic percent or less (excluding 0 atomic percent) of at least one selected from the group consisting of indium (In), bismuth (Bi), and zinc (Zn). These elements act to further reduce the oxidative degradation of tin as a main component of the recording layer and to further increase the durability of the recording layer.

These indium (In), bismuth (Bi), and zinc (Zn) are elements more susceptible to oxidation than tin (Sn). They sacrificially act to prevent the oxidative degradation of tin. This effect can be exhibited even in a very small total content of at least one of indium (In), bismuth (Bi), and zinc (Zn, and the total content is not limited in terms of the lower limit. However, for practically effectively exhibiting the effect, the total content of at least one of indium (In), bismuth (Bi), and zinc (Zn) in a tin-based alloy, if selectively contained, is preferably about 3 atomic percent or more, and more preferably about 5 atomic percent or more. In contrast, if the total content is excessively large, the content of tin may be relatively small and the inherent actions of tin may not be effectively exhibited. Accordingly, the total content of at least one of indium (In), bismuth (Bi), and zinc (Zn) is, in terms of its upper limit, preferably about 30 atomic percent or less and more preferably about 25 atomic percent or less.

Thickness of Optical Recording Layer

An optical recording layer including the tin-based alloy may preferably have a thickness of about 1 to about 50 nm so as to yield a recording layer capable of reliably recording data with a stable precision, while the thickness may vary depending on the structure of the optical information recording medium. An optical recording layer having a thickness of less than about 1 nm may be susceptible to defects such as pores on its surface and thereby fail to provide a satisfactory recording sensitivity, even if an optical control layer and/or a dielectric layer is arranged adjacent to the optical recording layer. In contrast, an optical recording layer having a thickness exceeding about 50 nm may fail to form satisfactory recording marks, because heat applied by the application of laser beams excessively rapidly diffuses in such a thick recording layer. From the viewpoint of reflectivity as an optical disc, the thickness of the recording layer is more preferably about 8 nm or more and about 30 nm or less, and further preferably about 12 nm or more and about 20 nm or less when neither dielectric layer nor optical control layer is arranged. The thickness is more preferably about 3 nm or more and about 30 nm or less, and further preferably about 5 nm or more and about 20 nm or less when at least one of a dielectric layer and an optical control layer is arranged.

The thickness of a recording layer including the tin-based alloy is preferably within a range of about 1 to about 50 nm. The resulting layer can carry out recording with a stable accuracy. A tin-based alloy recording layer having a thickness within the above-specified range can yield an optical information recording medium that has a high recording sensitivity upon irradiation with laser beams having a wavelength of 350 to 700 nm and can carry out writing and reading of optical information with high accuracy.

An excessively thin recording layer having a thickness less than about 1 nm may be susceptible to defects such as pores on its surface. This may cause reduced recording accuracy. In contrast, an excessively thick recording layer having a thickness exceeding about 50 nm may fail to form satisfactory recording marks, because heat applied by laser beams excessively rapidly diffuses in the recording layer. From these viewpoints, the thickness of the recording layer is more preferably about 3 nm or more and about 45 nm or less, and further preferably about 5 nm or more and about 40 nm or less.

Dielectric Layers Including Oxides of Specific Elements

An optical information recording medium according to an embodiment of the present invention includes dielectric layers 3 and 5 adjacent to a tin-based alloy recording layer 4. The dielectric layers 3 and 5 each include at least one oxide of an elements elected from silicon (Si), magnesium (Mg), tantalum (Ta), zirconium (Zr), manganese (Mn), and indium (In). Examples of such oxides are SiO₂, MgO, Ta₂O₅, ZrO₂, MnO₂, and InO.

As is described above, the dielectric layers 3 and 5 mainly including these oxides function as dielectrics and, in addition, act to control the wettability of the tin-based alloy recording layer 4 during formation of local recording marks by the action of laser power. This control action avoids or reduces the problem specific to a tin-based alloy recording layer. Namely, the action suppresses the uneven distribution of tin as droplets derived from melted tin or as residual solidified lamps of tin during formation of local recording marks by the action of laser power. Thus, local recording marks can be formed satisfactorily. This prevents decrease in degree of signal modulation. These dielectric layers 3 and 5 also act as a dielectric layer to protect the recording layer 4 to thereby increase the durability and prolong the storage period of information in the recording layer 4. In addition, they act to increase the reflectivity and the C/N ratio.

The action of controlling the wettability of the tin-based alloy recording layer during formation of local recording marks by the action of laser power is none or is very small, if a recording medium contains no dielectric layer mainly containing at least one oxide of an element selected from the group consisting of silicon (Si), magnesium (Mg), tantalum (Ta), zirconium (Zr), manganese (Mn), and indium (In), or if it contains one or more dielectric layers each having a composition not mainly containing oxides of these specific elements. In the latter case, the dielectric layers, however, exhibit some dielectric functions.

More specifically, if tin shows excessively high wettability during the formation of local recording marks, melted tin does not spread over grooves having a constant track pitch (guide grooves or pits) but often locally remains as droplets in the pots where holes or pits are formed by melting tin. Conversely, if tin shows poor wettability, melted tin is unevenly distributed typically on vertical walls around the grooves and is solidified therein as lamps. This may also possibly prevent the change in reflectivity in the recording marks and may suppress the degree of signal modulation. In any case, the reflectivity in the recording marks may be prevented from changing and the degree of signal modulation may be suppressed. Materials for constituting dielectric layers having no or very small action of controlling the wettability of the tin-based alloy recording layer include, for example, ZnS—SiO₂, ZnS, oxides and nitrides typically of Si, Al, Zr, Ti, Ta, and Cr, carbides of Si and Ti, BN, carbon (C), and mixtures of these.

Location of Dielectric Layer

To exhibit these effects satisfactorily, an optical information recording medium according to an embodiment of the present invention includes a dielectric layer, which dielectric layer mainly contains at least one of the specific oxides and is arranged adjacent to the tin-based alloy recording layer. The dielectric layer mainly containing the specific oxide is preferably arranged between the substrate and the recording layer containing a tin-based alloy. The dielectric layer may act to control the wettability of tin and to prevent decrease in degree of signal modulation even when it is arranged only one side of the recording layer, namely, on a side of the recording layer facing the substrate, or on the other side opposite to the substrate. The dielectric layer can more satisfactorily exhibit these actions when it is arranged on both sides of the recording layer.

Thickness of Oxide Dielectric Layer

The thickness of a dielectric layer mainly including at least one oxide of an element selected from the group consisting of silicon (Si), magnesium (Mg), tantalum (Ta), zirconium (Zr), manganese (Mn), and indium (In) is preferably about 5 to about 200 nm and more preferably about 10 to about 150 nm for effectively suppressing decrease in degree of signal modulation. Such preferred ranges, however, may vary depending on the structure of the optical information recording medium. An excessively thin dielectric layer having a thickness less than about 5 nm may not satisfactorily exhibit the actions. In contrast, an excessively thick dielectric layer may not exhibit further increased actions and may cause disadvantages such as decreased productivity of the optical information recording medium. Accordingly, the thickness may be preferably set at 200 nm or less.

Such dielectric layers mainly containing oxides of specific elements can be deposited by any procedure. They are preferably deposited by sputtering.

Other preferred conditions and structures as an optical recording medium, of an optical information recording medium according to an embodiment of the present invention will be illustrated below.

Materials

An optical disc according to a representative embodiment of the present invention includes a supporting substrate 1 and an optical control layer 2, in addition to a recording layer 4 and dielectric layers 3 and 5. Materials for the supporting substrate 1 and the optical control layer 2 are not specifically limited, and materials generally used can be used herein as appropriate. Preferred materials for the supporting substrate include generally used materials such as polycarbonate resins, norbornene resins, cyclic olefin copolymers, and amorphous polyolefins. Preferred materials for the optical control layer are metals such as Ag, Au, Cu, Al, Ni, Cr, and Ti, and alloys of these metals.

Wavelength of Laser Beam

A laser beam to be applied for information recording preferably has a wavelength of about 350 to about 700 nm. A laser beam having an excessively short wavelength less than about 350 nm may be significantly absorbed typically by a covering layer (light transmission layer) and may not sufficiently contribute to the writing/reading of information on an optical recording layer. In contrast, a laser beam having an excessively long wavelength exceeding about 700 nm may have a decreased energy and may not sufficiently contribute to the formation of recording marks on an optical recording layer. From these viewpoints, a laser beam for use in information recording may have a wavelength of more preferably about 350 nm or more and about 660 nm or less, and further preferably about 380 nm or more and about 650 nm or less.

Sputtering

When the recording layer and the dielectric layer are deposited by sputtering, targets for use in sputtering may have compositions basically the same as a desired alloy composition and a desired oxide composition of the recording layer and the dielectric layer, respectively. In other words, the recording layer and the dielectric layer having a desired alloy composition and a desired oxide composition, respectively, can be deposited by sputtering by using sputtering targets having compositions as with the alloy composition and the oxide composition of the recording layer and the dielectric layer, respectively.

In this connection, a recording layer including a tin-based alloy for use in an embodiment of the present invention is especially preferably deposited by sputtering. Specifically, the respective alloy elements other than tin for use in an embodiment of the present invention have specific solid solubility limits with respect to tin in thermal equilibrium. Accordingly, when thin films for constituting the layers are deposited by sputtering, the alloy elements are uniformly dispersed in a tin matrix. The resulting thin film layers thereby have uniformly distributed compositions so as to yield stable optical properties and stable environmental resistance.

When a recording layer including a tin-based alloy for use in an embodiment of the present invention is deposited by sputtering, the sputtering target is preferably a tin-based alloy prepared by melting and casting (hereinafter also referred to as “ingot tin-based alloy target”). This is because such an ingot tin-based alloy target has a uniform texture, shows a stable sputtering rate, and emits atoms at uniform angles. Thus, the target contributes to the deposition of a recording layer having a homogenous alloy composition, and this in turn contributes to the production of an optical disc being homogenous and having high performance.

Trace amounts of impurities such as nitrogen, oxygen, and other gaseous components in atmosphere, and components of a melting furnace may contaminate a target during its preparation. The compositions of a recording layer and targets for use according to an embodiment of the present invention do not specify these inevitable trace components (impurities). Trace amounts of such inevitable impurities may be contained, as long as they do not adversely affect the advantages and properties obtained according to embodiments of the present invention.

The present invention will be illustrated in further detail with reference to several examples below. It should be noted, however, the following examples does not limit the scope of the present invention, and appropriate modifications and variations without departing from the spirit and scope of the present invention set forth above and below fall within the technological scope of the present invention.

### EXAMPLES

A series of an optical disc 10 having a basic structure shown in FIG. 1A or 1B was prepared by sequentially forming, on a supporting substrate 1, a dielectric layer 3, a recording layer 4, and a light transmission layer 6 in this order. The degrees of signal modulation upon reading of signals of these optical discs were determined. The results are shown in Table 1. The results demonstrate that optical discs according to Examples 1 to 6 each having a dielectric layer mainly including an oxide of the specific elements as specified according to an embodiment of the present invention show significantly higher degrees of signal modulations than optical discs according to Comparative Example 7 having a dielectric layer containing ZnS—SiO₂ and Comparative Example 8 having no dielectric layer.

Tin-Based Alloy for Recording Layer

A tin-based alloy for constituting the recording layer (recording film) 4 used herein was a recording layer including Sn-20 at. % Ni-3 at. % Y. This combination of elements is based on a preferred combination of element, namely, a combination of tin (Sn), at least one of nickel and cobalt, and at least one rare-earth element. The compositions of deposited recording layers were determined by inductively coupled plasma atomic emission spectrochemical analysis and inductively coupled plasma mass spectrometry.

Dielectric Layer

The dielectric layer 3 used herein is as follows. With reference to Table 1, Examples 1 to 6 use oxides SiO₂, MgO, Ta₂O₅, ZrO₂, MnO₂, and InO, respectively, as the dielectric layer 3. Comparative Example 7 uses ZnS—SiO₂ in related art as the dielectric layer 3. Comparative Example 8 has no dielectric layer 3. Other conditions for preparing Comparative Examples 7 and 8 were the same as in Examples 1 to 6.

In addition, another series of optical discs was prepared by the above procedure, except for depositing recording layers from tin-based alloys having compositions other than the Sn—Ni—Y composition. The degrees of signal modulation upon reading of signals of these optical discs were determined. These tin-based alloys have compositions of Sn-20 at. % Co, Sn-20 at. % Ni-10 at. % In, and Sn-20 at. % Ni-3 at. % Y-10 at. % In, respectively. The results demonstrate that samples each having a dielectric layer mainly including an oxide of the specific elements as specified according to an embodiment of the present invention show significantly higher degrees of signal modulations than a comparative sample having a dielectric layer containing ZnS—SiO₂ and a comparative sample having no dielectric layer, as with the optical discs according to Examples 1 to 6 each having a Sn—Ni—Y alloy recording layer.

Preparation of Disc

A disc substrate (supporting substrate) 1 used herein was a polycarbonate substrate having a diameter of 120 mm, a thickness of 1.1 mm, a track pitch of 0.32 μm, a groove width of 0.16 μm, and a groove depth of 25 nm.

In every sample, a dielectric layer 3 having a thickness of 10 nm was deposited on the substrate 1 by radio frequency (RF) magnetron sputtering. Sputtering targets were targets having a diameter of 6 inches and having the same compositions as the oxides and ZnS—SiO₂, respectively. Sputtering in every sample was carried out at a base pressure of 10⁻⁵ Torr or less (1 Torr=133.3 Pa), an argon (Ar) gas pressure of 2 mTorr and a radio frequency sputtering power of 200 W.

The tin-based alloy recording layer 4 having a thickness of 10 nm was deposited on the dielectric layer 3 by DC magnetron sputtering in every sample. The sputtering target was a target having a diameter of 6 inches and having a composition of Sn-20 at. % Ni-3 at. % Y, the same as the desired composition of the tin-based alloy recording layer 4. In addition, recording layers having other compositions were deposited by using targets having compositions the same as the desired compositions of the recording layer. Sputtering in every sample was carried out at a base pressure of 10⁻⁵ Torr or less (1 Torr=133.3 Pa), an argon (Ar) gas pressure of 2 mTorr and a DC sputtering power of 50 W.

A film of an ultraviolet-curable resin (a product of Nippon Kayaku Co., Ltd. under the trade name of “BRD-130”) was applied to the recording layer 4 by spin coating, the applied film was irradiated with and cured by ultraviolet rays and thereby yielded a light transmission layer 6 having a thickness of 100±15 μm.

Determination of Degree of Signal Modulation of Optical Disc

In the determination, there were used an optical disc drive evaluation unit (a product of Pulstec Industrial Co., Ltd. under the trade name of “ODU-1000”, having a recording laser wavelength of 405 nm and a numerical aperture (NA) of 0.85) and a digital oscilloscope (a product of Yokogawa Electric Corporation under the trade name of “DL1640L”). Specifically, recording marks each having a length of 0.46 μm were repeatedly formed at a laser power of 8 mW and a linear velocity of 4.9 m/s. These signals were read out at a laser power of 0.3 mW, and the degree of signal modulation was determined.

The degree of signal modulation of a sample was evaluated in terms of degree of signal modulation at a laser power of 8 mW according to the following criteria, and the results are shown in Table 1. In Table 1, percentages in compositions are atomic percent.

Excellent: 60% or more

Good: more than 40% and 60% or less

Fair: more than 20% and 40% or less

Poor: 20% or less

Table 1 demonstrates that optical discs according to Examples 1 to 6 including dielectric layers mainly containing oxides SiO₂, MgO, Ta₂O₅, ZrO₂, MnO₂, and InO, respectively, have significantly high degrees of signal modulation as compared with optical discs according to Comparative Example 7 having a dielectric layer containing ZnS—SiO₂ and Comparative Example 8 having no dielectric layer.

TABLE 1

| | | | | Properties of optical disc | |
|---|---|---|---|---|---|
| | | Optical Disc | | Degree of | |
| | | Composition of | Composition of | modulation at | |
| | | recording layer 4 | dielectric | laser power | |
| | Number | (atomic percent) | layer 3 | of 8 mW | Evaluation |
| Example | 1 | Sn—20% Ni—3% Y | SiO₂ | 78% | Excellent |
| Example | 2 | Sn—20% Ni—3% Y | MgO | 55% | Good |
| Example | 3 | Sn—20% Ni—3% Y | Ta₂O₅ | 54% | Good |
| Example | 4 | Sn—20% Ni—3% Y | ZrO₂ | 54% | Good |
| Example | 5 | Sn—20% Ni—3% Y | MnO₂ | 50% | Good |
| Example | 6 | Sn—20% Ni—3% Y | InO | 50% | Good |
| Com. Ex. | 7 | Sn—20% Ni—3% Y | ZnS—SiO₂ | 16% | Poor |
| Com. Ex. | 8 | Sn—20% Ni—3% Y | none | 37% | Fair |

Determination of Basic Properties of Optical Disc

The optical discs according to Examples 1 to 6 and Comparative Examples 7 and 8 were determined on basic properties as optical discs, including the noise, C/N ratio, recording sensitivity, and change in reflectivity (environmental resistance). The results demonstrate that the optical discs according to Examples 1 to 6 and Comparative Examples 7 and 8 each have a noise of −55 dB or less, a C/N ratio of more than 45 dB, a recording sensitivity less than 10 mW, and a change in reflectivity of 10% or less and are passed in terms of basic properties as optical discs.

These results demonstrate that the dielectric layers mainly containing oxides SiO₂, MgO, Ta₂O₅, ZrO₂, MnO₂, and InO, respectively, in optical discs according to Examples 1 to 6 exhibit their functions so as to satisfy basic properties as optical discs, in combination with tin-based alloy recording layers.

Determination Methods of Basic Properties of Optical Disc

The basic properties including noise, C/N ratio, and recording sensitivity of the optical discs according to Examples 1 to 6 and Comparative Examples 7 and 8 were determined at a linear velocity of 5.28 m/s using an optical disc drive evaluation unit and a spectrum analyzer. The optical disc drive evaluation unit was a product of Pulstec Industrial Co., Ltd. under the trade name of “ODU-1000”, having a recording laser wavelength of 405 nm and a numerical aperture (NA) of 0.85. The spectrum analyzer was a product of Advantest Corporation (Japan) under the trade name of “R3131R”.

The determined properties are (1) a noise level of an unrecorded disc at a frequency of 16.5 MHz; (2) a C/N ratio at a frequency of 16.5 MHz where 2 T rectangular pulses were recorded on a disc; (3) a recording sensitivity at such a recording laser power as to yield a maximum C/N ratio; and (4) a reflectivity as a disc. The reflectivity as a disc was determined assuming that a SUM2 level of 320 mV corresponds to a reflectivity of 16%. This assumption was based on the determination result of a SUM2 level of a commercially available Blu-ray disc rewritable (BD-RE).

In addition, environmental resistance tests were conducted to determine the change in reflectivity (environmental resistance) as optical discs. Specifically, the optical discs according to Examples 1 to 6 and Comparative Examples 7 and 8 were placed in a thermohygrostat tester at a temperature of 80° C. and relative humidity of 85% for ninety-six hours, the reflectivities with respect to a laser beam having a wavelength of 405 nm were determined using a spectrophotometer (a product of JASCO Corporation under the trade name of “V-570”), and changes in reflectivity between before and after the tests were determined. The environmental resistance tests are durability tests under conditions of higher temperature and higher humidity for a longer period of time than the durability tests for optical discs described typically in above-mentioned JP-A No. 2004-5922 and JP-A No. 2001-180114.

According to embodiments of the present invention, there are provided optical information recording media each having a recording layer containing a tin-based alloy and showing a high degree of signal modulation and superior basic properties as optical discs. Accordingly, optical information recording media according to embodiments of the present invention are usable as current optical information recording media such as CDs (compact discs) and DVDs (digital versatile discs), and next-generation optical information recording media such as HDDVDs and Blu-ray discs. In particular, they can be advantageously used as write-once high-density optical information recording media configured to be applied with blue-violet laser beams.

While preferred embodiments have been described, it should be understood by those skilled in the art that various modifications, combinations, subcombinations, and alterations may occur depending on design requirements and other factors insofar as they are within the scope of the appended claims or the equivalents thereof.

What is claimed is:

1. An optical information recording medium comprising:
a substrate; and
a recording layer arranged on or above the substrate and configured to bear recording marks upon irradiation of energy beams,
wherein the recording layer includes a tin-based alloy,
wherein the optical information recording medium further includes at least one dielectric layer adjacent to the recording layer, and
wherein the at least one dielectric layer mainly includes at least one oxide of an element selected from the group consisting of silicon (Si), magnesium (Mg), tantalum (Ta), zirconium (Zr), manganese (Mn), and indium (In).

2. The optical information recording medium according to claim 1, wherein the at least one dielectric layer is arranged between the recording layer and the substrate.

3. The optical information recording medium according to claim 1, wherein the tin-based alloy comprises 1 to 50 atomic percent of at least one of nickel (Ni) and cobalt (Co) and 0.5 to 10 atomic percent of at least one rare-earth element, with the remainder being tin (Sn) and inevitable impurities.
